(19) United States
(12) Patent Application Publication
(10) Pub. No.: US 2008/0224675 A1
(43) Pub. Date: Sep. 18, 2008

(54) VOLTAGE REGULATOR AND VOLTAGE REGULATION METHOD

(76) Inventor: Yoshiki Takagi, Takarazuka-shi (JP)

Correspondence Address: DICKSTEIN SHAPIRO LLP, 1825 EYE STREET NW, Washington, DC, 20006-5403, US

(21) Appl. No.: 12/046,190

(22) Filed: Mar. 11, 2008

(30) Foreign Application Priority Data
Mar. 14, 2007 (JP) 2007-064506

(51) Int. Cl. G05F 1/565

(52) U.S. Cl. 323/275

(57) ABSTRACT

A voltage regulator converts a voltage from a direct current power supply into a predetermined voltage, and outputs the predetermined voltage from an output terminal thereof to supply electric power to a load. The voltage regulator includes a first power supply circuit and a second power supply circuit. The first power supply circuit supplies the electric power to the load in accordance with a switching signal, when a load current is relatively high. The second power supply circuit supplies the electric power to the load in accordance with the switching signal, when the load current is relatively low. A bias current for operating the second power supply circuit is set to be proportional to the load current during the supply of the electric power to the load by the second power supply circuit.

### CROSS REFERENCE TO RELATED APPLICATION

This application claims priority to Japanese Patent Application no. 2007-064506, filed on Mar. 14, 2007, the entire contents of which are hereby incorporated by reference herein.

### BACKGROUND OF THE INVENTION

1. Field of the Invention

The present invention relates to a voltage regulator and a voltage regulation method for switching between a power supply circuit for a heavy load and a power supply circuit for a light load, and particularly to a voltage regulator and a voltage regulation method capable of reducing the fluctuation of an output voltage in a switch from the power supply circuit for a heavy load to the power supply circuit for a light load.

2. Discussion of the Background Arts

To improve the Power Supply Ripple Rejection (PSRR) and the load transient response performance of a voltage regulator, the consumption current of the voltage regulator needs to be increased.

A device such as a mobile phone has an operating state requiring a relatively high PSRR and relatively high load transient response performance, in which the device is operated with normal consumption of current, and a standby state such as a standby mode not requiring the high-speed response performance, in which the device is operated with relatively low consumption of current. If such a device uses a voltage regulator which has the high-speed response performance and consumes a relatively large amount of current, the voltage regulator unnecessarily consumes a relatively large amount of current in the standby state.

In view of the above, a first background technique changes the current supplied to an error amplifier circuit of the voltage regulator in accordance with a load current to secure the high-speed response performance when the load current is relatively high, and to reduce the consumption current of the voltage regulator when the load current is relatively low.

Further, a second background technique includes a first constant voltage circuit which consumes a relatively large amount of current and has a relatively high PSRR and relatively high load transient response performance, and a second constant voltage circuit which consumes a relatively small amount of current and has a relatively low PSRR and relatively low load transient response performance. The two constant voltage circuits are operated in accordance with a switching signal output from a load circuit such that the first constant voltage circuit is operated for a heavy load and the second constant voltage circuit is operated for a light load, such as in the standby mode.

The second constant voltage circuit is placed in the standby state during the operation of the first constant voltage circuit, and the first constant voltage circuit is placed in the standby state during the operation of the second constant voltage circuit. Thereby, the consumption current of the unused one of the two constant voltage circuits is reduced to suppress an increase in the overall consumption current of the constant voltage circuits.

A third background technique includes a delay circuit to provide a time period in which the first constant voltage circuit and the second constant voltage circuit simultaneously operate in a switch between the two constant voltage circuits. Thereby, a reduction in an output voltage occurring in the switch is prevented. Due to the provision of the delay circuit, however, the circuit is increased in size and complicated in configuration.

In the first background technique, a transistor constituting the voltage regulator is selected on the basis of an assumed maximum load current. Thus, the consumption current cannot be substantially reduced. Therefore, in a state in which the consumption current is substantially low, such as in the standby mode of the mobile phone, the amount of the unnecessarily consumed current is still relatively large.

Meanwhile, if the consumption current of the unselected one of the constant voltage circuits is reduced, as in the second background technique, the activation of the constant voltage circuit takes time. As a result, the output voltage is substantially reduced in the switch between the first and second constant voltage circuits. Such a disadvantage is conspicuous particularly when the second constant voltage circuit is brought into operation with the first constant voltage circuit brought into a non-operating state.

Further, the multifunctionalization of devices has been in progress in recent years, and the dynamic range of the operating current has been expanding to cover a situation in which the devices are operated with a substantially light load in a normal operating state, and also a situation in which the load current is substantially increased due to the simultaneously operation of a multitude of functions. Thus, if the first constant voltage circuit having the relatively large consumption current is used in the other states excluding the standby state, the efficiency obtained when the load is relatively light is reduced in the normal operating state.

Further, in the third background technique, in the switch from the constant voltage circuit having a higher output voltage to the constant voltage circuit having a lower output voltage, the constant voltage circuit having a lower output voltage does not start operating until the output voltage of the constant voltage circuit having a higher output voltage is reduced, if there is any difference in the output voltage between the two constant voltage circuits, irrespective of the provision of the time period in which the two constant voltage circuits simultaneously operate. As a result, the operation of the constant voltage circuit having a lower output voltage does not start until the completion of the operation of the constant voltage circuit having a higher output voltage. Therefore, there is a need to match the output voltages of the two constant voltage circuits with high accuracy. Thus, the background technique is disadvantageous in terms of the component accuracy and the cost. Further, the background technique does not address the above-described phenomenon that the efficiency obtained when the load is relatively light is reduced in the normal operating state.

### SUMMARY OF THE INVENTION

This patent specification describes a voltage regulator for converting a voltage from a direct current power supply into a predetermined voltage and outputting the predetermined voltage from an output terminal thereof to supply electric power to a load. In one example, a voltage regulator includes a first power supply circuit and a second power supply circuit. The first power supply circuit supplies the electric power to the load in accordance with a switching signal, when a load current is relatively high. The second power supply circuit supplies the electric power to the load in accordance with the switching signal, when the load current is relatively low. A bias current for operating the second power supply circuit is set to be proportional to the load current during the supply of the electric power to the load by the second power supply circuit.

This patent specification further describes another voltage regulator for converting a voltage from a direct current power supply into a predetermined voltage and outputting the predetermined voltage from an output terminal thereof to supply electric power to a load. In one example, a voltage regulator includes first power supply means and second power supply means. The first power supply means supplies the electric power to the load in accordance with a switching signal, when a load current is relatively high. The second power supply means supplies the electric power to the load in accordance with the switching signal, when the load current is relatively low. A bias current for operating the second power supply means is set to be proportional to the load current during the supply of the electric power to the load by the second power supply means.

This patent specification further describes a voltage regulation method for converting a voltage from a direct current power supply into a predetermined voltage and outputting the predetermined voltage to supply electric power to a load. In one example, a voltage regulation method includes: preparing a first power supply circuit and a second power supply circuit for supplying the electric power to the load in accordance with a switching signal; causing the first power supply circuit to supply the electric power to the load in accordance with the switching signal, when a load current is relatively high; and causing the second power supply circuit to supply the electric power to the load in accordance with the switching signal, when the load current is relatively low. A bias current for operating the second power supply circuit is set to be proportional to the load current during the supply of the electric power to the load by the second power supply circuit.

### BRIEF DESCRIPTION OF THE DRAWINGS

A more complete appreciation of the invention and many of the advantages thereof are obtained as the same becomes better understood by reference to the following detailed description when considered in connection with the accompanying drawings, wherein:

FIG. 1 is a block diagram of a voltage regulator for explaining an overview of an embodiment of the present invention;

FIG. 2 is a circuit diagram illustrating an embodiment of the voltage regulator illustrated in FIG. 1;

FIG. 3 is a circuit diagram selectively illustrating a second power supply circuit of a voltage regulator according to the second embodiment of the present invention;

FIG. 4 is a circuit diagram selectively illustrating a second power supply circuit of a voltage regulator according to the third embodiment of the present invention;

FIG. 5 is a circuit diagram selectively illustrating a second power supply circuit of a voltage regulator according to the fourth embodiment of the present invention;

FIG. 6 is a circuit diagram selectively illustrating a second power supply circuit of a voltage regulator according to the fifth embodiment of the present invention;

FIG. 7 is a circuit diagram selectively illustrating a second power supply circuit of a voltage regulator according to the sixth embodiment of the present invention;

FIG. 8 is a circuit diagram selectively illustrating a second power supply circuit of a voltage regulator according to the seventh embodiment of the present invention;

FIG. 9 is a circuit diagram selectively illustrating a second power supply circuit of a voltage regulator according to the eighth embodiment of the present invention;

FIG. 10 is a graph illustrating the relationship between a load current and a bias current of a second error amplifier circuit in each of the embodiments of the present invention; and

FIG. 11 is a graph illustrating changes in the output voltage of the sixth embodiment of the present invention (indicated by the solid line F in FIG. 10) and a background example caused by a load fluctuation.

### DETAILED DESCRIPTION OF THE INVENTION

In describing the embodiments illustrated in the drawings, specific terminology is employed for the purpose of clarity. However, the disclosure of this patent specification is not intended to be limited to the specific terminology so used, and it is to be understood that substitutions for each specific element can include any technical equivalents that operate in a similar manner.

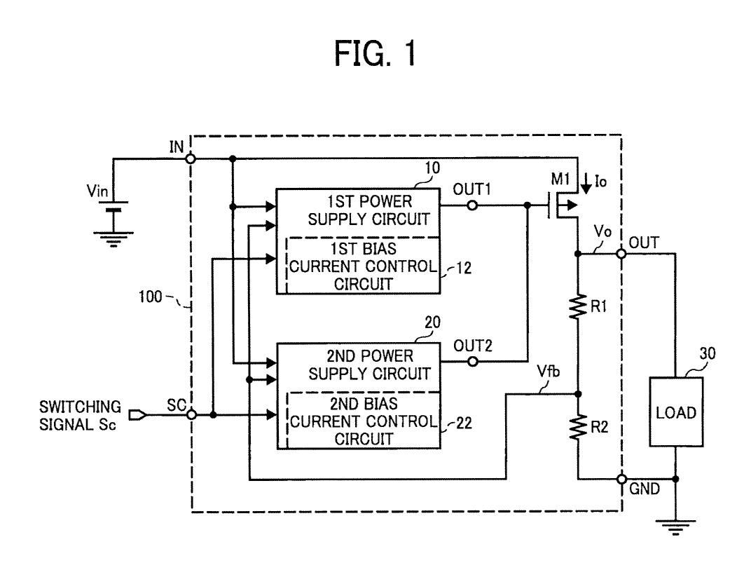

Referring now to the drawings, wherein like reference numerals designate identical or corresponding parts throughout the several views, particularly to FIG. 1, detailed description will be made of embodiments of a voltage regulator according to the present invention. FIG. 1 is a block diagram for explaining an overview of a voltage regulator according to an embodiment of the present invention.

In FIG. 1, the reference numeral 100 denotes a voltage regulator which has an input terminal IN applied with an input voltage Vin from a direct current power supply, an output terminal OUT and a ground terminal GND having a load 30 connected therebetween, and a terminal SC input with a switching signal Sc.

The switching signal Sc changes in level in accordance with a load current Io flowing through a later-described output transistor M1. For example, if the load current Io reaches or exceeds a predetermined current value Io1, the switching signal Sc shifts to a HIGH level. Meanwhile, if the load current Io falls to or below a predetermined current value Io2 lower than the predetermined current value Io1, the switching signal Sc shifts to a LOW level. The switching signal Sc may be output from a control circuit (not illustrated) included in the load 30, or may be generated on the basis of the detection of the load current Io.

The voltage regulator 100 includes a first power supply circuit 10, a second power supply circuit 20, the output transistor M1 including a PMOS (P-channel Metal Oxide Semiconductor) transistor, and resistors R1 and R2 for detecting an output voltage V0.

The output transistor M1 has a source connected to the input voltage Vin via the input terminal IN, a drain connected the output terminal OUT and to the ground terminal GND via the series-connected resistors R1 and R2, and a gate connected to output terminals OUT1 and OUT2 of the first power supply circuit 10 and the second power supply circuit 20 later described.

The first power supply circuit 10 and the second power supply circuit 20 are input with the input voltage Vin, the switching signal Sc, and an output detection voltage Vfb divided from the output voltage V0 by the resistors R1 and R2. Further, the output from the first power supply circuit 10 and the output from the second power supply circuit 20 are output from the output terminals OUT1 and OUT2, respectively, and are connected to the gate of the output transistor M1, as described above.

Further, the first power supply circuit 10 includes a first bias current control circuit 12 for controlling a bias current thereof in accordance with the load current Io, and the second power supply circuit 20 includes a second bias current control circuit 22 for controlling a bias current thereof in accordance with the load current Io.

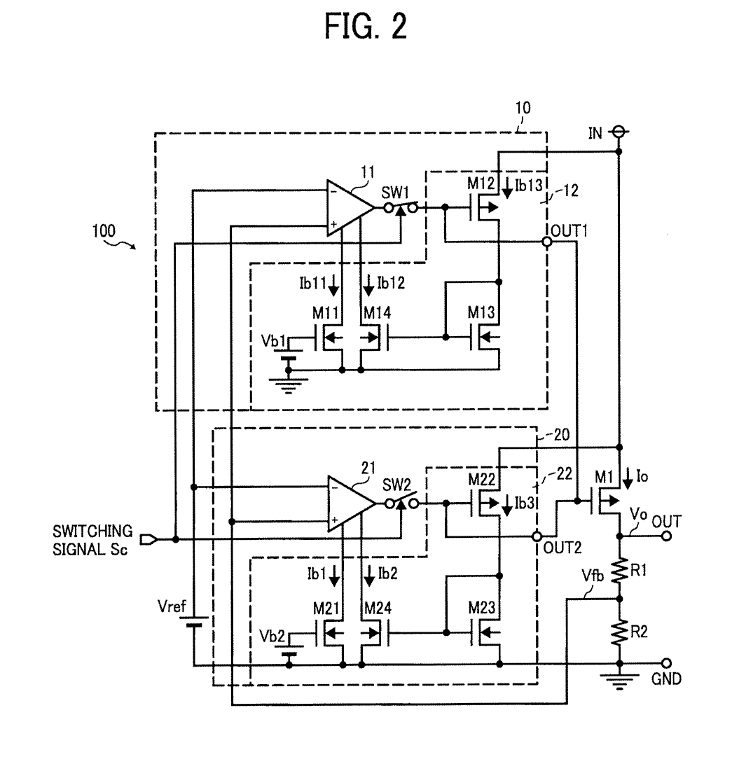

The first embodiment of the present invention will now be described. FIG. 2 is a circuit diagram illustrating the first embodiment of the voltage regulator 100 illustrated in FIG. 1. In FIG. 2, the same circuits and components as the circuits and components of FIG. 1 are assigned with the same reference numerals.

In FIG. 2, the first power supply circuit 10 includes a first error amplifier circuit 11, a switching device SW1 controlled by the switching signal Sc, and the first bias current control circuit 12.

The first bias current control circuit 12 includes a PMOS transistor M12, NMOS (N-channel Metal Oxide Semiconductor) transistors M11, M13, and M14, and a bias power supply Vb1.

The NMOS transistor M11 has a source of the connected to the ground, and a drain connected to a first bias terminal of the first error amplifier circuit 11. A bias voltage from the bias power supply Vb1 is applied between a gate and the source of the NMOS transistor M11. Thus, the NMOS transistor M11 outputs a constant current from the drain thereof, and supplies a first bias current Ib11 to the first error amplifier circuit 11.

The PMOS transistor M12 has a source connected to the source of the output transistor M1 and to the input voltage Vin via the input terminal IN. The PMOS transistor M12 further has a gate connected to the gate of the output transistor M1. Thus, the PMOS transistor M12 and the output transistor M1 constitute a current mirror circuit. The gate of the PMOS transistor M12 is further connected to the output of the first error amplifier circuit 11 via the switching device SW1.

The PMOS transistor M12 further has a drain connected to the drain of the NMOS transistor M13. The NMOS transistor M13 has a source connected to the ground, and a gate connected to the drain thereof and the gate of the NMOS transistor M14.

The NMOS transistor M14 has a source connected to the ground. Thus, the NMOS transistors M13 and M14 constitute a current mirror circuit. The NMOS transistor M14 further has a drain connected to a second bias terminal of the first error amplifier circuit 11.

As described above, the output transistor M1 and the PMOS transistor M12 constitute a current mirror circuit. Thus, the load current Io is proportional to a drain current Ib13 of the PMOS transistor M12. The drain current Ib13 also constitutes a drain current of the NMOS transistor M13. The NMOS transistors M13 and M14 constitute another current mirror circuit. Thus, a drain current Ib12 of the NMOS transistor M14 is also proportional to the load current Io. That is, the bias current supplied to the second bias terminal of the first error amplifier circuit 11 changes in accordance with the load current Io.

The first error amplifier circuit 11 has an inverting input terminal applied with a reference voltage Vref, and a non-inverting input terminal applied with the output detection voltage Vfb divided from the output voltage V0 by the resistors R1 and R2.

The switching device SW1 has a control terminal connected to the switching signal Sc, and the switching device SW1 is turned ON when the load current Io reaches or exceeds the predetermined current value Io1.

Upon turn-on of the switching device SW1, the output of the first error amplifier circuit 11 is connected to the gate of the output transistor M1. The first error amplifier circuit 11 controls a gate voltage of the output transistor M1 such that the output detection voltage Vfb is equal to the reference voltage Vref. Thus, a constant voltage proportional to the reference voltage Vref is output from the output terminal OUT as the output voltage V0.

The drain current Ib12 constituting a second bias current of the first error amplifier circuit 11 is proportional to the load current Io. Thus, the first error amplifier circuit 11 operates at a relatively high efficiency over a relatively wide current range of the load current Io from the above-described predetermined current value Io1 to the maximum load current value. In addition, the first error amplifier circuit 11 can obtain a necessary response speed.

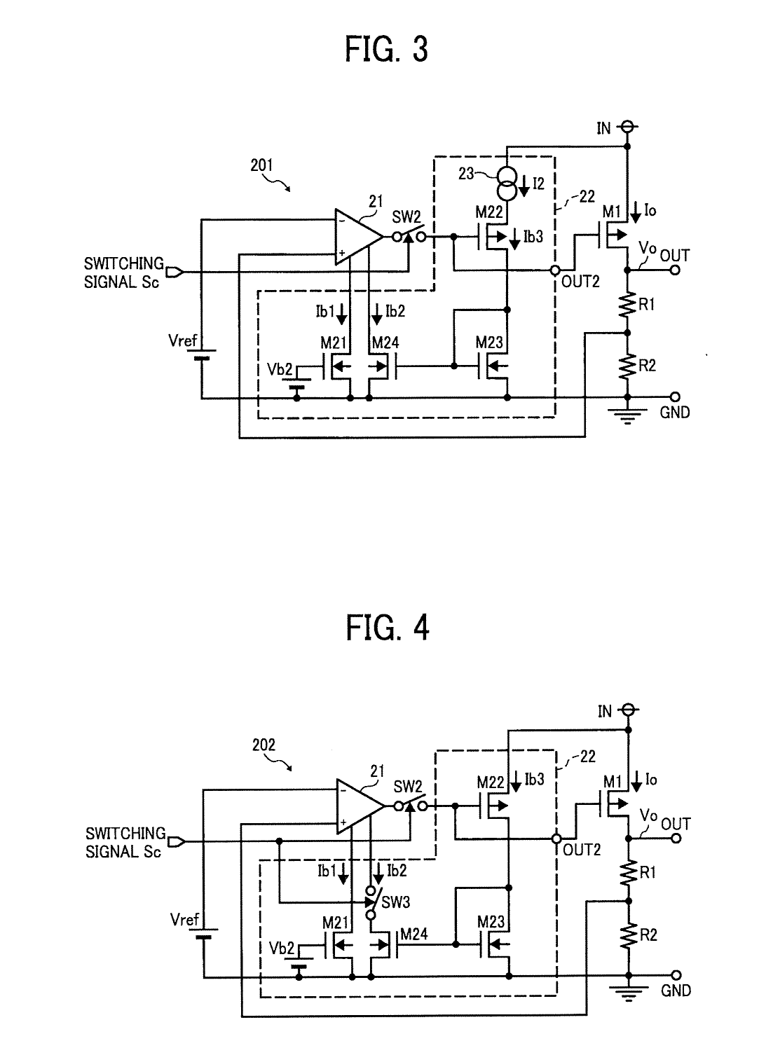

If the drain current Ib12 constituting the second bias current of the first error amplifier circuit 11 is further increased after the drain current Ib12 has been increased to reach a predetermined current value, the effect of improving the PSRR and the load transient response performance is reduced. It is therefore desired to provide a device (not illustrated) for limiting the drain current of the PMOS transistor M12 at a predetermined current value. Such a device can be easily provided by a later-described circuit illustrated in FIG. 3.

The second power supply circuit 20 includes a second error amplifier circuit 21, a switching device SW2 controlled by the switching signal Sc, and the second bias current control circuit 22. The reference voltage Vref is supplied to both the first power supply circuit 10 and the second power supply circuit 20.

The second bias current control circuit 22 includes a PMOS transistor M22, NMOS transistors M21, M23, and M24, and a bias power supply Vb2. The circuit configuration of the second bias current control circuit 22 is the same as the circuit configuration of the above-described first bias current control circuit 12, and thus detailed description thereof will be omitted.

The switching device SW2 has a control terminal connected to the switching signal Sc. The switching signal Sc complementarily turns ON and OFF the switching device SW2 and the switching device SW1 of the first power supply circuit 10. Thus, the switching device SW2 is ON in a range of the load current Io from zero ampere to the above-described predetermined current value Io1.

When the switching device SW2 is ON, the output of the second error amplifier circuit 21 is connected to the gate of the output transistor M1. Thus, the second error amplifier circuit 21 controls the gate voltage of the output transistor M1 such that the output detection voltage Vfb is equal to the reference voltage Vref.

As the bias current of the second error amplifier circuit 21 of the second power supply circuit 20, a constant current Ib1 constituting a drain current of the NMOS transistor M21 (hereinafter referred to as the first bias current Ib1) is supplied to a first bias terminal of the second error amplifier circuit 21, and a drain current Ib2 of the NMOS transistor M24 proportional to the load current Io (hereinafter referred to as the second bias current Ib2) is supplied to a second bias terminal of the second error amplifier circuit 21.

The load current Io controlled by the second power supply circuit 20 is substantially low, i.e., a few tenths to a few hundredths of the load current Io controlled by the first power supply circuit 10. Therefore, a MOS transistor constituting the second power supply circuit 20 includes a device operated by a lower bias current than the bias current for operating a MOS transistor constituting the first power supply circuit 10, and thus is operated by the lower bias current. Accordingly, the second power supply circuit 20 can operate at a relatively high efficiency in a relatively wide range of situations from a state in which the load current Io hardly flows, as in a standby state, to a state in which the load is relatively light and thus the efficiency is reduced if the first power supply circuit 10 is used.

Further, the second power supply circuit 20 is configured such that the second bias current Ib2 supplied to the second bias terminal of the second error amplifier circuit 21 changes in accordance with the load current Io even after the load current Io has reached or exceeded the above-described predetermined current value Io1, as indicated by the solid line A in FIG. 10.

FIG. 10 is a graph illustrating the relationship between the load current Io and the bias current (i.e., the sum of the first bias current Ib1 and the second bias current Ib2) of the second error amplifier circuit 21 in each of the embodiments of the present invention. The vertical axis represents the bias current (i.e., Ib1+Ib2) of the second error amplifier circuit 21, and the horizontal axis represents the load current Io.

When the load current Io is zero ampere, the second bias current Ib2 constituting the drain current of the NMOS transistor M24 is also zero ampere. Thus, as indicated by the solid line A in FIG. 10, the first bias current Ib1 constituting the drain current of the NMOS transistor M21 solely constitutes the bias current of the second error amplifier circuit 21. As the load current Io is increased, the bias current of the second error amplifier circuit 21 is linearly increased. Then, at a point A, the switching device SW2 is turned OFF, and the bias current of the second error amplifier circuit 21 continues to increase with the same gradient even after the operation of the voltage regulator 100 has switched to the first power supply circuit 10.

As described above, the bias current (i.e., Ib1+Ib2) of the second error amplifier circuit 21 is increased in accordance with the load current Io. Thus, even if the load current Io is rapidly reduced from a relatively large current value to or below the predetermined current value Io2 (i.e., the heavy-to-light switching current Io2 in FIG. 10) in a shift to the standby state or a shift back to the operation of the second power supply circuit 20, the bias current of the second error amplifier circuit 21 immediately before the shift is relatively large. Thus, the power supply circuit can be switched from the first power supply circuit 10 to the second power supply circuit 20 without a sharp reduction in the output voltage V0.

The second embodiment of the present invention will now be described. FIG. 3 is a circuit diagram selectively illustrating a second power supply circuit 201 of a voltage regulator according to the second embodiment of the present invention. The present embodiment is different from the first embodiment of FIG. 2 in that a constant current source 23 is inserted between the drain of the PMOS transistor M22 and the input terminal IN.

The constant current source 23 has a current value I2 set to a current value equal to or greater than the value of the second bias current Ib2 obtained when the power supply circuit switches from the second power supply circuit 201 to the first power supply circuit 10.

Therefore, the second bias current Ib2 of the second error amplifier circuit 21 does not exceed the current value I2 of the constant current source 23, no matter how much the load current Io is increased. Thus, when the load current Io is relatively low, the bias current of the second error amplifier circuit 21 is equal to the bias current indicated by the solid line A in FIG. 10. When the bias current reaches a current value I2+Ib1, however, the bias current becomes a constant current, as indicated by the broken line B.

As described above, if the bias current is further increased after the bias current has reached a predetermined value, the effect of improving the PSRR and the load transient response performance is reduced. With the present configuration, therefore, an unnecessary increase in the bias current of the second error amplifier circuit 21 can be prevented.

The third embodiment of the present invention will now be described. FIG. 4 is a circuit diagram selectively illustrating a second power supply circuit 202 of a voltage regulator according to the third embodiment of the present invention. The present embodiment is different from the first embodiment of FIG. 2 in that a switching device SW3 is inserted between the drain of the NMOS transistor M24 and the second bias terminal of the second error amplifier circuit 21.

The switching device SW3 has a control terminal connected to the switching signal Sc. The switching device SW3 is turned ON and OFF in synchronization with the switching device SW2.

Therefore, if the load current Io is increased and reaches the predetermined current value Io1 (i.e., the light-to-heavy switching current Io1 in FIG. 10), the switching device SW3 is turned OFF. Thus, the first bias current Ib1 constituting the drain current of the NMOS transistor M21 solely constitutes the bias current of the second error amplifier circuit 21. That is, the bias current of the second error amplifier circuit 21 increases along the solid line A in FIG. 10 in the range of the load current Io from zero ampere to the predetermined current value Io1. Then, when the bias current reaches the point A, the switching device SW3 is turned OFF, and thus the bias current falls to the value of the first bias current Ib1. Thereafter, the bias current remains unchanged irrespective of the increase in the load current Io, as indicated by the solid line C.

The present embodiment is effective when it is known that the load current Io is always relatively low immediately before the operation of the voltage regulator 100 switches from the first power supply circuit 10 to the second power supply circuit 202. This is because, in such a case, a rapid fluctuation in the output voltage V0 does not occur at the time of the switch, even if the bias current of the second error amplifier circuit 21 is relatively low.

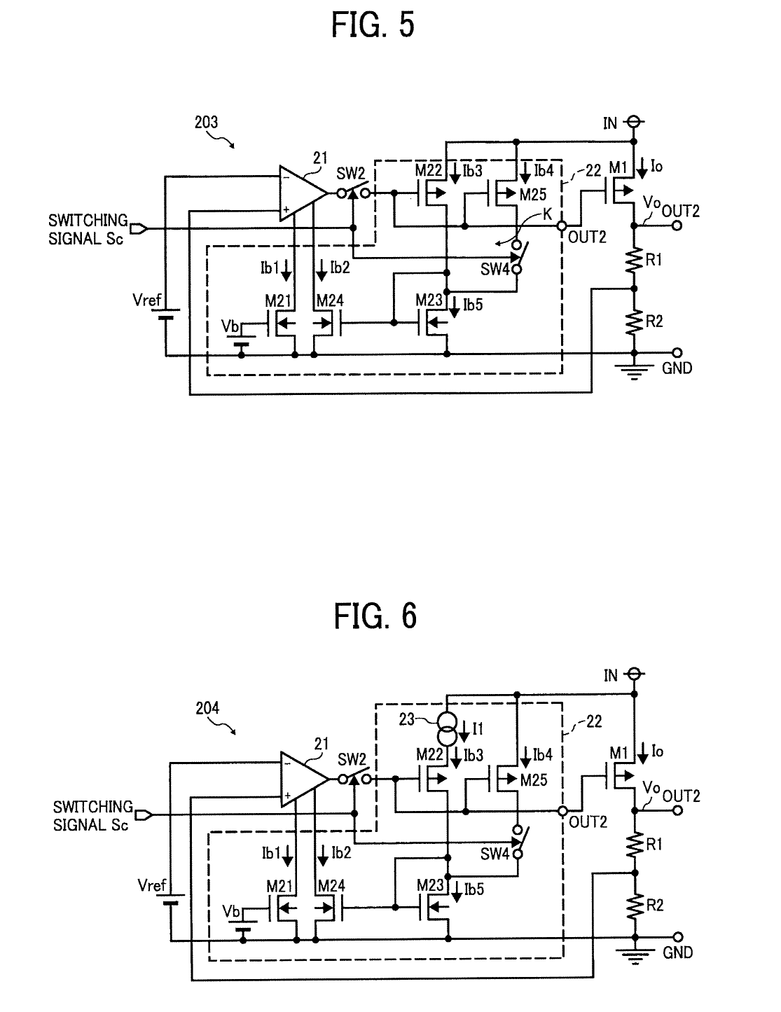

The fourth embodiment of the present invention will now be described. FIG. 5 is a circuit diagram selectively illustrating a second power supply circuit 203 of a voltage regulator according to the fourth embodiment of the present invention. The present embodiment is different from the first embodiment of FIG. 2 in that a PMOS transistor M25 and a switching device SW4 are additionally provided.

The PMOS transistor M25 has a source and a gate commonly connected to the source and the gate of the output transistor M1, respectively. Thus, the PMOS transistor M25 and the output transistor M1 constitute a current mirror circuit. The PMOS transistor M25 further has a drain connected to one end of the switching device SW4. The other end of the switching device SW4 is connected to the drain of the NMOS transistor M23.

The switching device SW4 has a control terminal connected to the switching signal Sc. The switching device SW4 is turned ON and OFF in synchronization with the switching device SW2.

For example, it is now assumed that the device size of the PMOS transistor M22 of FIG. 2 is equal to the sum of the device sizes of the PMOS transistors M22 and the M25 of FIG. 5. In this case, the bias current of the second error amplifier circuit 21 increases along the solid line A in FIG. 10 in the range of the load current Io from zero ampere to the predetermined current value Io1. Then, when the bias current reaches the point A, the switching device SW4 is turned OFF, and thus the supply of a portion of the bias current supplied by a drain current Id4 of the PMOS transistor M25 is stopped. As a result, the bias current is reduced to a point B in FIG. 10. Thereafter, however, the bias current increases in accordance with the increase in the load current Io, as indicated by the solid line D, since the PMOS transistor M22 remains connected to the second error amplifier circuit 21. The degree of increase, however, is reduced.

For example, if the PMOS transistors M22 and M25 of FIG. 5 have the same device size, the bias current at the point B is obtained from the subtraction of half the current value I0−Ib1 (i.e., the current value obtained from the subtraction of the first bias current Ib1 from a bias current I0 at the point A) from the bias current I0 at the point A. The rate of increase after the turn-off of the switching device SW4 is half the rate of increase indicated by the solid line A.

The fifth embodiment of the present invention will now be described. FIG. 6 is a circuit diagram selectively illustrating a second power supply circuit 204 of a voltage regulator according to the fifth embodiment of the present invention. The present embodiment is different from the fourth embodiment of FIG. 5 in that the constant current source 23 is inserted between the drain of the PMOS transistor M22 and the input terminal IN. The constant current source 23 has a current value I1 set to a current value equal to or greater than the value of the second bias current Ib2 at the point B in FIG. 10.

Therefore, no matter how much the load current Io is increased, the bias current of the second error amplifier circuit 21 does not exceed the sum current of the current value I1 of the constant current source 23 and the first bias current Ib1 constituting the drain current of the NMOS transistor M21 (i.e., I1+Ib1). Thus, the bias current of the second error amplifier circuit 21 increases along the solid line A in FIG. 10 in the range of the load current Io from zero ampere to the predetermined current value Io1. Then, when the bias current reaches the point A, the switching device SW4 is turned OFF, and the bias current is reduced to the current value at the point B. Thereafter, however, the bias current increases along the solid line D in accordance with the increase in the load current Io, since the PMOS transistor M22 remains connected to the second error amplifier circuit 21. Then, after the bias current reaches the sum current of the current value I1 of the constant current source 23 and the first bias current Ib1 constituting the drain current of the NMOS transistor M21 (i.e., I1+Ib1), the bias current is not increased and has a constant current value indicated by the broken line E.

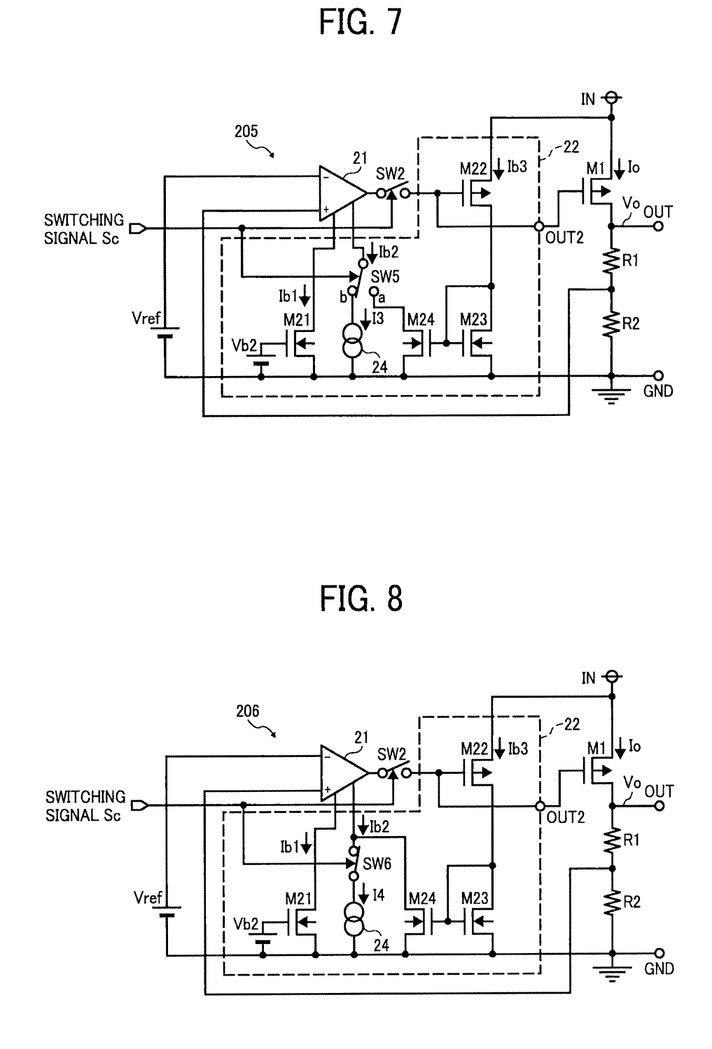

The sixth embodiment of the present invention will now be described. FIG. 7 is a circuit diagram selectively illustrating a second power supply circuit 205 of a voltage regulator according to the sixth embodiment of the present invention. The present embodiment is different from the first embodiment of FIG. 2 in that a constant current source 24 and a switching device SW5 are additionally provided.

The switching device SW5 constitutes a change-over switch having a common contact connected to the second bias terminal of the second error amplifier circuit 21, a contact a connected to the drain of the NMOS transistor M24, and a contact b connected to one end of the constant current source 24. The other end of the constant current source 24 is connected to the ground.

The switching device SW5 further has a control terminal connected to the switching signal Sc. When the switching device SW2 is ON, the common contact of the switching device SW5 is connected to the contact a. Meanwhile, when the switching device SW2 is OFF, the common contact of the switching device SW5 is connected to the contact b.

The constant current source 24 has a current value I3 set to a current value equal to or greater than the value of the second bias current Ib2 at the point A illustrated in FIG. 10.

Therefore, if the load current Io is increased to reach the predetermined current value (i.e., the light-to-heavy switching current) Io1, and then if the switching device SW5 switches from the contact a to the contact b, the bias current of the second error amplifier circuit 21 becomes equal to the sum of the first bias current Ib1 supplied by the NMOS transistor M21 and the current value I3 of the constant current source 24.

That is, the bias current of the second error amplifier circuit 21 increases along the solid line A in FIG. 10 in the range of the load current Io from zero ampere to the predetermined current value Io1. Then, when the bias current reaches the point A, the switching device SW5 switches to the contact b, and the bias current increases to reach a current value I3+Ib1. Thereafter, however, there is no bias current proportional to the load current Io. As a result, even if the load current Io is increased thereafter, the bias current remains unchanged, as indicated by the solid line F in FIG. 10.

The seventh embodiment of the present invention will now be described. FIG. 8 is a circuit diagram selectively illustrating a second power supply circuit 206 of a voltage regulator according to the seventh embodiment of the present invention. The present embodiment is different from the sixth embodiment of FIG. 7 in that a switching device SW6 replaces the switching device SW5, and that the current value of the constant current source 24 is changed to I4.

The switching device SW6 constitutes an ON-OFF switch having a control terminal connected to the switching signal Sc, and performs a complementary ON-OFF operation with the switching device SW2. The current value I4 of the constant current source 24 is an arbitrary current value.

If the load current Io is increased to reach the predetermined current value (i.e., the light-to-heavy switching current) Io1, and then if the switching device SW6 is turned ON, the bias current of the second error amplifier circuit 21 includes the first bias current Ib1 supplied by the NMOS transistor M21, the second bias current Ib2 constituting the drain current of the NMOS transistor M24, and the current value I4 of the constant current source 24. If the load current Io is further increased, the second bias current Ib2 constituting the drain current of the NMOS transistor M24 is further increased. As a result, the bias current is further increased.

That is, the bias current of the second error amplifier circuit 21 increases along the solid line A in FIG. 10 in the range of the load current Io from zero ampere to the predetermined current value Io1. Then, when the bias current reaches the point A, the switching device SW6 is turned ON, and thus the current value I4 is added to the bias current by the constant current source 24. FIG. 10 illustrates a case in which the current value obtained from the addition is equal to the current value I3+Ib1. If the load current Io is further increased, the bias current continues to increase in proportion to the load current Io, as indicated by the solid line G.

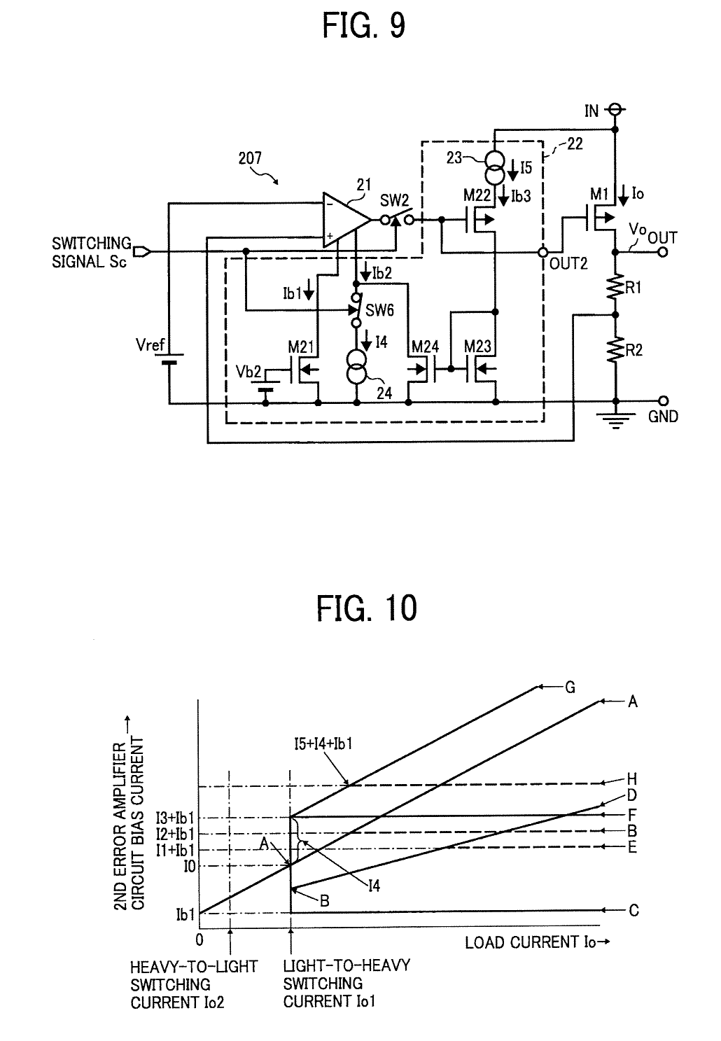

The eighth embodiment of the present invention will now be described. FIG. 9 is a circuit diagram selectively illustrating a second power supply circuit 207 of a voltage regulator according to the eighth embodiment of the present invention. The present embodiment is different from the seventh embodiment of FIG. 8 in that the constant current source 23 is inserted between the drain of the PMOS transistor M22 and the input terminal IN.

The constant current source 23 has a current value I5 set to a current value equal to or greater than the value of the second bias current Ib2 at the point A illustrated in FIG. 10.

In the present embodiment, the bias current of the second error amplifier circuit 21 changes as follows.

The bias current of the second error amplifier circuit 21 increases along the solid line A in FIG. 10 in the range of the load current Io from zero ampere to the predetermined current value Io1. Then, when the bias current reaches the point A, the switching device SW6 is turned ON, and thus the bias current increases to reach a current value I0+14, which is equal to the current value I3+Ib1 in FIG. 10. If the load current Io is further increased, the bias current increases along the solid line G. Then, when the bias current reaches a current value I5+14+Ib1, the increase in the bias current is stopped, and the bias current becomes a constant current, as indicated by the broken line H.

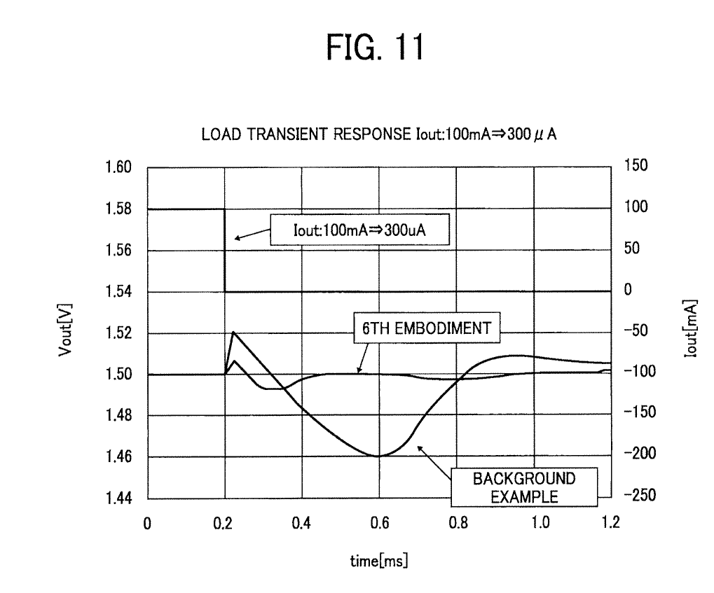

Description will now be made of the comparison of an embodiment of the present invention with a background example. FIG. 11 illustrates the result of comparison of the load transient response performance between a circuit according to an embodiment of the present invention and a background circuit. The sixth embodiment is herein presented as a typical example of the present invention. The bias current of the second error amplifier circuit of the background circuit has a fixed current value of 0.2 microamperes. Further, the background example has an output voltage of 1.5 volts, an input voltage of 2.5 volts, an output capacitance Cout of 1 microfarad, a load current shifted from 100 milliamperes to 300 microamperes, and a rise time Tr of 50 nanoseconds. In the sixth embodiment indicated by the solid line F in FIG. 10, the bias current of the second error amplifier circuit 21 is supplied with a sufficient current of approximately 5 microamperes while a current of 100 milliamperes is reduced from the load. Thus, even if the load is rapidly reduced, the fluctuation of the output voltage V0 is substantially small, as compared with the waveform of the background example.

In all of the above-described embodiments of the present invention, the second error amplifier circuit 21 of the second power supply circuits 20 and 201 to 207 (hereinafter collectively referred to as the second power supply circuit 20) continues to be supplied with the bias current even after the operation of the voltage regulator 100 has switched to the first power supply circuit 10. Thereby, the embodiments of the present invention can reduce the fluctuation of the output voltage V0 in the switch from the first power supply circuit 10 to the second power supply circuit 20.

The value of the bias current of the second power supply circuit 20 during the operation of the first power supply circuit 10 needs to be determined by the value of the load current Io expected to be obtained immediately before the switch from the first power supply circuit 10 back to the second power supply circuit 20.

That is, if it is known that the load current Io immediately before the switch of the operation of the voltage regulator 100 back to the second power supply circuit 20 is relatively low, it is preferred to reduce the bias current of the second error amplifier circuit 21, as described in the third to fifth embodiments.

Further, if the load current Io immediately before the switch of the operation of the voltage regulator 100 back to the second power supply circuit 20 is always relatively high, it is preferred to increase the bias current of the second error amplifier circuit 21, as in the sixth to eighth embodiments.

Further, if the load current Io immediately before the switch of the operation of the voltage regulator 100 back to the second power supply circuit 20 cannot be predicted, it is preferred to set the bias current of the second error amplifier circuit 21 to be proportional to the load current Io, as in the first and second embodiments.

Furthermore, if the bias current is further supplied with current after the bias current has been supplied with a predetermined amount of current, the effect commensurate with the further supply of current cannot be obtained. Therefore, to set the upper limit of the bias current, as described in the second, fifth, and eighth embodiments, is substantially effective from the perspective of power saving.

The above-described embodiments use, as the output transistor, the output transistor M1 common to the first power supply circuit 10 and the second and power supply circuit 20. Alternatively, separate output transistors may be prepared and controlled for the first power supply circuit 10 and the second and power supply circuit 20. In such a case, the load current Io may be detected by a method using a voltage drop across a current detection resistor provided on an output pathway, for example.

Further, the above-described embodiments are configured to have two separate bias currents, i.e., the first bias current and the second bias current, as the bias current applied to an error amplifier circuit. However, the configuration does not necessarily need to be limited thereto. Thus, the bias current may be supplied by a single system, or may be separately supplied by three or more systems.

The above-described embodiments are illustrative and do not limit the present invention. Thus, numerous additional modifications and variations are possible in light of the above teachings. For example, elements at least one of features of different illustrative and exemplary embodiments herein may be combined with each other at least one of substituted for each other within the scope of this disclosure and appended claims. Further, features of components of the embodiments, such as the number, the position, and the shape, are not limited the embodiments and thus may be preferably set. It is therefore to be understood that within the scope of the appended claims, the disclosure of this patent specification may be practiced otherwise than as specifically described herein.

1. A voltage regulator for converting a voltage from a direct current power supply into a predetermined voltage and outputting the predetermined voltage from an output terminal thereof to supply electric power to a load, the voltage regulator comprising:
a first power supply circuit configured to supply the electric power to the load in accordance with a switching signal, when a load current is relatively high; and
a second power supply circuit configured to supply the electric power to the load in accordance with the switching signal, when the load current is relatively low,
wherein a bias current for operating the second power supply circuit is set to be proportional to the load current during the supply of the electric power to the load by the second power supply circuit.

2. The voltage regulator as described in claim 1,
wherein the bias current of the second power supply circuit is supplied during the supply of the electric power to the load by the first power supply circuit.

3. The voltage regulator as described in claim 1,
wherein, during the supply of the electric power to the load by the first power supply circuit, the bias current of the second power supply circuit is changed in accordance with the load current.

4. The voltage regulator as described in claim 3,
wherein, when the bias current of the second power supply circuit reaches a predetermined current value, an increase in the bias current of the second power supply circuit is stopped.

5. The voltage regulator as described in claim 1,
wherein, when the first power supply circuit starts supplying the electric power to the load in accordance to the switching signal, the bias current of the second power supply circuit becomes a constant current lower than a value of the bias current of the second power supply circuit obtained at the time of a switch from the second power supply circuit to the first power supply circuit.

6. The voltage regulator as described in claim 1,
wherein, when the first power supply circuit starts supplying the electric power to the load in accordance to the switching signal, the bias current of the second power supply circuit is reduced to be lower than a value of the bias current of the second power supply circuit obtained at the time of a switch from the second power supply circuit to the first power supply circuit, and thereafter is changed in accordance with the load current.

7. The voltage regulator as described in claim 6,
wherein, when the bias current of the second power supply circuit reaches a predetermined current value, an increase in the bias current of the second power supply circuit is stopped.

8. The voltage regulator as described in claim 1,
wherein, when the first power supply circuit starts supplying the electric power to the load in accordance to the switching signal, the bias current of the second power supply circuit becomes a constant current higher than a value of the bias current of the second power supply circuit obtained at the time of a switch from the second power supply circuit to the first power supply circuit.

9. The voltage regulator as described in claim 1,
wherein, when the first power supply circuit starts supplying the electric power to the load in accordance to the switching signal, the bias current of the second power supply circuit is increased to be higher than a value of the bias current of the second power supply circuit obtained at the time of a switch from the second power supply circuit to the first power supply circuit, and thereafter is changed in accordance with the load current.

10. The voltage regulator as described in claim 9,
wherein, when the bias current of the second power supply circuit reaches a predetermined current value, an increase in the bias current of the second power supply circuit is stopped.

11. The voltage regulator as described in claim 1,
wherein a bias current of the first power supply circuit is increased in accordance with the load current.

12. The voltage regulator as described in claim 11,
wherein, when the bias current of the first power supply circuit reaches a predetermined current value, the increase in the bias current of the first power supply circuit is stopped.

13. The voltage regulator as described in claim 1,
wherein a value of the load current at which the power supply circuit for supplying the electric power to the load is switched from the second power supply circuit to the first power supply circuit in accordance with the switching signal is higher than a value of the load current at which the power supply circuit is switched from the first power supply circuit to the second power supply circuit in accordance with the switching signal.

14. A voltage regulator for converting a voltage from a direct current power supply into a predetermined voltage and outputting the predetermined voltage from an output terminal thereof to supply electric power to a load, the voltage regulator comprising:
first power supply means for supplying the electric power to the load in accordance with a switching signal, when a load current is relatively high; and
second power supply means for supplying the electric power to the load in accordance with the switching signal, when the load current is relatively low,
wherein a bias current for operating the second power supply means is set to be proportional to the load current during the supply of the electric power to the load by the second power supply means.

15. A voltage regulation method for converting a voltage from a direct current power supply into a predetermined voltage and outputting the predetermined voltage to supply electric power to a load, the voltage regulation method comprising:
preparing a first power supply circuit and a second power supply circuit for supplying the electric power to the load in accordance with a switching signal;
causing the first power supply circuit to supply the electric power to the load in accordance with the switching signal, when a load current is relatively high; and
causing the second power supply circuit to supply the electric power to the load in accordance with the switching signal, when the load current is relatively low,
wherein a bias current for operating the second power supply circuit is set to be proportional to the load current during the supply of the electric power to the load by the second power supply circuit.
